(19) United States
(12) Patent Application Publication
(10) Pub. No.: US 2006/0236338 A1
(43) Pub. Date: Oct. 19, 2006

(54) Recording and reproducing apparatus, and recording and reproducing method

(75) Inventor: Nozomu Shimoda, Ninomiya (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/368,702

(22) Filed: Mar. 7, 2006

(30) Foreign Application Priority Data
Apr. 19, 2005 (JP) 2005-120482

(51) Int. Cl. H04N 5/445

(52) U.S. Cl. 725/37

(57) ABSTRACT

The present invention is intended to make it possible to retrieve a desired scene from among numerous scenes by utilizing metadata that is recorded together with audiovisual data. Metadata describing each scene contained in audiovisual data recorded on a recording medium is analyzed and transformed into a metadata structure in which scenes are subordinated to each keyword. Moreover, transformed metadata is contained in a file, and then read in order to provide a scene retrieving feature that utilizes keywords.

### BACKGROUND OF THE INVENTION

1. Field of the Invention

The present invention relates to a recording and reproducing apparatus and a recording and reproducing method.

2. Description of the Related Art

An optical disk and other recording media in or from which a content such as a movie or a sports game is recorded or reproduced using a home reproducing apparatus have widely prevailed. A representative recording medium is a so-called digital versatile disc (DVD). A Blu-ray disc (BD) offering a larger storage capacity has made its debut in recent years.

An apparatus for recording or reproducing video on or from an optical disk has been devised and put to practical use. For example, Japanese Unexamined Patent Publication No. 2003-123389 (Patent Document 1) has disclosed a recording and reproducing apparatus that records or reproduces video data on or from an optical disk. The publication relates to a recording medium reproducing apparatus that makes it possible to record a flag, which is used to manage reproduction and control of audiovisual (AV) data, on a disk, and to use the flag to control reproduction by performing a simple manipulation. The publication reads that when the keystroke of a security code is stipulated in order to reproduce both a directory and a play list, the security code should be entered only once.

Moreover, the recording media offer such a large storage capacity that video which lasts for a long time can be recorded therein. Therefore, a variety of movies or dramas that last for a long time, a series of programs, or a plurality of different programs can be recorded according to the likes of a contents maker or a user. In order to select a desired scene from recorded video, fast reproduction is conventionally performed in order to search the desired scene. However, along with an increase in the storage capacity of recording media, the number of recorded video data items and a recording time are increasing. The work of retrieving video data or retrieving a specific scene from video data is getting harder.

As a method for solving the foregoing problem and simplifying selection of a desired scene, a technique of recording a content and relevant metadata and using the metadata to select a scene has been proposed. The metadata is, concretely speaking, information on each scene such as a location, cast, or lines. A user can readily search a desired scene by retrieving metadata. Japanese Unexamined Patent Publication No. 2002-244900 (Patent Document 2) describes a recording and reproducing apparatus that records metadata together with a content on a recording medium and manages it. The publication reads that an object of the invention is to provide a content recording apparatus that, when a content file and a metadata file are recorded separately from each other, can hold the relationship of correspondence between the files. The publication reads that a solving means accomplishes the object by using a metadata management file to manage the relationship of correspondence between an identifier of a metadata file and an identifier of an object.

On the other hand, a method of transforming a metadata structure from one to another according to the predefined relationship of correspondence among metadata and a metadata conversion device are described in Japanese Unexamined Patent Publication No. 2002-49636 (Patent Document 3). The publication reads that an object of the invention is to provide a metadata transformation device capable of diversely and flexibly transforming metadata from one based on one terminology to another based on another terminology by stipulating a small number of rules of correspondence. A solving means is described to include: a metadata input/output unit 101 that samples an attribute and an attribute value from metadata that is a source of transformation and that includes a thesaurus containing attribute values that have a parent-child relationship or a brotherhood; an attribute transformation unit 105 that transforms one attribute to another attribute, which is contained in a schema employing a different terminology, using an attribute relationship-of-correspondence data storage unit 103; a schema data storage unit 107 in which a thesaurus of an attribute that is a source of transformation and a thesaurus of an attribute that is a destination of transformation are stored; an attribute value transformation unit 111 that transforms the sampled attribute value into an attribute value, which is contained in the schema, using an inter-thesaurus node relationship-of-correspondence data storage unit 109; and a thesaurus retrieval unit 113 that retrieves an upper-level or lower-level attribute value of an attribute value, that is a source of transformation, using an intra-thesaurus node hierarchal relationship data storage unit 115 in which parent-child relationships of attribute values contained in a thesaurus are stored.

### SUMMARY OF THE INVENTION

When a scene is sampled or retrieved based on metadata recorded in relation to video data, problems described below have arisen.

Specifically, the unique definition of a metadata structure is needed to keep video data interchangeable among pieces of equipment that record or reproduce the video data. However, if one metadata structure is employed, it is hard to provide diverse features or satisfy all users. Depending on situations, for example, the property of a content, a user's audiovisual means, and a user's searching habit, the employment of only one metadata structure may be found inconvenient.

As a solution of the above problem, a method allowing contents to contain metadata in different structures is conceivable. However, if a contents provider determines a metadata structure at their own convenience, equipment for reproducing the contents may not be able to read any information. Consequently, no metadata may be utilized. Moreover, when contents contain metadata in different structures, a large storage capacity is required for the metadata. Furthermore, when a plurality of metadata structures is created and recorded, the contents provider has to perform labor-intensive work. Consequently, the price of each content increases or an event that discourages a user is likely to take place.

In consideration of the foregoing points, the provision of a plurality of metadata structures for respective contents brings about many drawbacks. Preferably, a reproducing apparatus transforms metadata, which is recorded in a predetermined structure in relation to a content, into metadata of a structure that is convenient to a user. Herein, for example, Patent Document 3 has disclosed a metadata transformation method and a metadata transformation device offering the metadata transformation feature. Patent Document 3 is intended to facilitate the efficiency of a retrieval service provided on a network, but does not describe a method of creating, recording, or utilizing video data and relevant metadata. Moreover, Patent Document 3 does not take account of transformation of a metadata structure based on the property of a content or user's likes.

An object of the present invention is to improve the user-friendliness of a recording and reproducing apparatus.

The present invention provides a feature that is based on metadata of a predetermined structure and that is offered by equipment-which records or reproduces video data, and also provides a retrieving feature and a user interface that read and utilize metadata which has been transformed and recorded.

### BRIEF DESCRIPTION OF THE DRAWINGS

FIG. 1 is a block diagram showing a reproducing apparatus in accordance with the present invention;

FIG. 2 shows a directory structure on an optical disk employed in the present invention;

FIG. 3 shows a metadata structure that has keywords subordinated to each scene and that is employed in the present invention;

FIG. 4 shows an example of scene data display achieved by utilizing metadata (display of data belonging to each hierarchical level);

FIG. 5 shows an example of scene data display achieved by utilizing metadata (display of data of all hierarchical levels);

FIG. 6 shows a metadata structure that has scenes subordinated to each keyword;

FIG. 7 shows an example of display of a scene retrieval screen image through which a scene is retrieved based on a keyword;

FIG. 8 is a flowchart describing a metadata structure transformation procedure;

FIG. 9 is a flowchart describing metadata structure transformation;

FIG. 10 is a block diagram of a network-connectable reproducing apparatus;

FIG. 11 is a block diagram showing a recording apparatus in accordance with the present invention; and

FIG. 12 is a block diagram showing a recording and reproducing apparatus that supports digital broadcasting.

### DESCRIPTION OF THE PREFERRED EMBODIMENTS

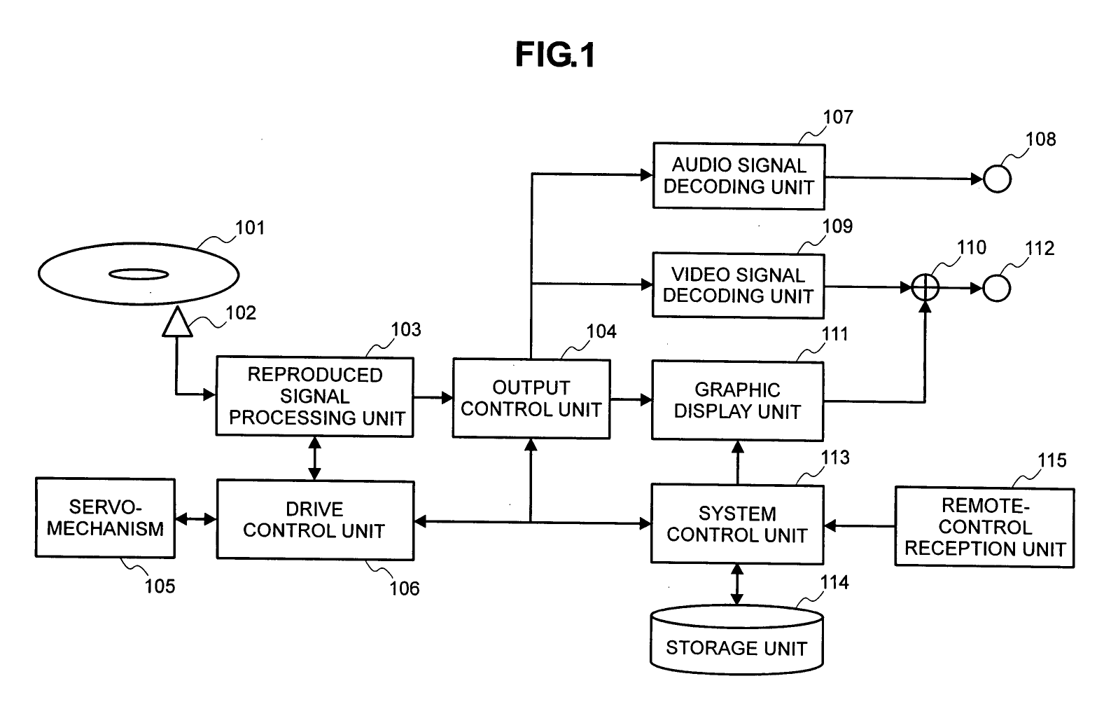

FIG. 1 is a block diagram of a reproducing apparatus in accordance with the present invention. Referring to FIG. 1, there are shown: an optical disk 101 on which video data and relevant character data are recorded; an optical pickup 102 that uses laser light to read information from the optical disk; a reproduced signal processing unit 103 that performs predetermined decoding on a signal read by the optical pickup and converts the resultant signal into a digital signal; an output control unit 104 that transforms the digital signal, which has been demodulated by the reproduced signal processing unit 103, into a predetermined packet, and transmits the packet; a servomechanism 105 that controls the rotating speed of the optical disk and the position of the optical pickup; a drive control unit 106 that controls the servomechanism 105 and reproduced signal processing unit 103; an audio signal decoding unit 107 that decodes an audio signal contained in an audio data packet received from the output control unit 104; an audio output terminal 108 via which the audio signal having been decoded by the audio signal decoding unit 107 is transmitted; a video signal decoding unit 109 that decodes a video signal contained in a video data packet received from the output control unit 104; a video signal synthesis unit 110 that synthesizes video signals; a graphic display unit 111 that displays a graphic; a video signal output terminal 112; a system control unit 113 that controls the entire system; a storage device 114, and a remote-control reception unit 115 that receives a control signal sent from a remote control (that is not shown).

Various data items are stored as files on the optical disk 101 according to a predetermined format. The various data items include: a transport stream into which packets of video and audio signals are multiplexed; play list data that indicates a sequence of reproducing streams; clip information containing information on the properties of respective streams; metadata describing the property of each scene; and a menu display program to be used to select a play list. What is referred to as a scene is a scene contained in video data. For example, if video data is compressed based on the MPEG2 coding method, a scene may be thought to correspond to one group of pictures (GOP) that is a set of about fifteen images. Furthermore, a scene may be regarded as one still image or a plurality of still images having a predetermined width.

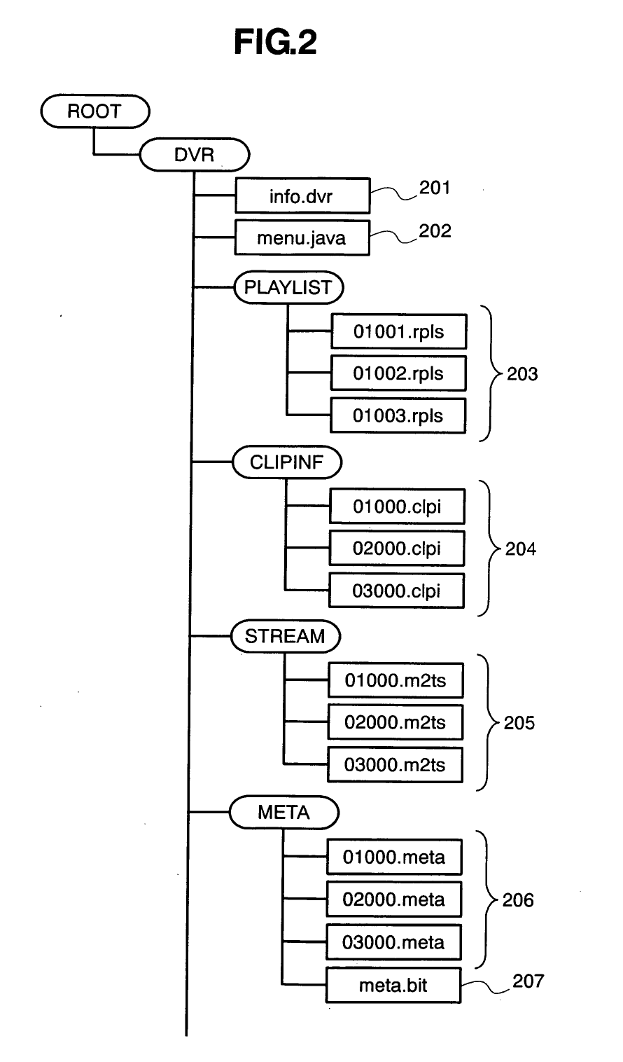

FIG. 2 shows a structure of directories and files on an optical disk employed in the present embodiment.

In the example of a data structure shown in FIG. 2, a directory DVR is created on an optical disk, and information files are contained in the directory.

In FIG. 2, there are shown: an info.dvr file 201 in which the number of play lists in the DVR directory, filenames therein, and other information are written; a menu.java file 202 in which a menu display program for displaying a menu is written; play list files 203 in which a sequence of reproducing streams is written; clip information files 204 in which reproduction time instants of packets contained in a stream file, the positions of the packets, and other information are written; stream files 205 in which video, sounds, and other information are written in a compressed form; metadata files 206 in which the properties of scenes represented by a stream are written; and a metadata structure identification file 207 in which information for use in identifying a metadata structure recorded on a disk is written.

Now, the stream file 205 will be described below.

Video data has a data rate thereof reduced according to the MPEG2 coding method that is one of image information compression technologies, transformed into a transport stream, and then recorded. The MPEG2 method effectively reduces a data rate of even an NTSC image or a high-definition (HD) image of high quality such as a Hi-Vision image. A data rate of compressed data is, for example, about 6 Mbps in case the data represents the NTSC image, and is about 20 Mbps in case the data represents the Hi-Vision image. Thus, the data rate is reduced with image quality held satisfactory. Therefore, image compression based on the MPEG2 method is applied to a wide range of usages including storage of an image on a recording medium such as a DVD and digital broadcasting.

A description will be made by taking the MPEG2 method for instance. Needless to say, any other image compression method, for example, the MPEG4 method can be employed in data coding without any problem.

Audio data has a data rate thereof reduced according to an audio compression technology such as the MPEG1 Audio coding method or the advanced audio coding (AAC) method that is adapted to broadcasting-satellite (BS) digital broadcasting. However, compared with the data rate of video data, the data rate of audio data is not large. Therefore, audio data may be recorded in an uncompressed form such as a linear pulse code modulation (PCD) form.

Video data and audio data which are coded as mentioned above are multiplexed into a transport stream so that they can be readily transmitted or stored, and then recorded as one file. The transport stream is composed of a plurality of fixed-length packets of 188 bytes long. A packet identifier PID and various flags are appended to each packet. Since a single identifier PID is assigned to each packet, the packet is readily identified during reproduction.

Aside from the video data and audio data, caption data, graphic data, a control command, and other various packets can be multiplexed into a transport stream. Moreover, a packet representing a program map table (PMT) or a program association table (PAT) is also combined with the video data and audio data as table data associated with each identifier PID. Thus, the transport stream is produced by multiplexing various data items, and recorded on the optical disk as one of the transport stream files 205.

Next, the clip information file 204 will be described below.

In a clip information file, a leading position of a group of pictures (GOP), that is, a set of images compressed according to the MPEG2 method, and coding times required by the respective images are written. The clip information file is used to retrieve a reproduction start position by executing search or skip.

The clip information file is associated with the transport stream file 205 on a one-to-one correspondence. For example, if a filename “01000.clpi” is written as a flip information file associated with a transport stream file 01000.m2ts, the correspondence between the files can be readily recognized. Reproduction of a retrieved scene is readily initiated.

Next, the play list file 203 will be described below.

The play list file is a file containing a list of filenames of transport stream files to be reproduced, reproduction start times, and reproduction end times. For example, if user's favorite scenes are collected and recorded as a play list, a favorite scene can be readily reproduced. At this time, since the play list file is edited independently of a transport stream file, the editing will not affect the original transport stream file. Moreover, a plurality of play list files may be recorded. For reproduction, a user selects any of the play list files through a menu display screen image.

Next, the metadata file 206 will be described below.

Metadata is data describing information on data. In general, metadata is intended to help search target information from among many data items. For example, when video data stored on a DVD is taken for instance, pieces of information such as a role played by a character appearing in each scene of a movie, an actor's name, a location, and lines each refer to metadata. Metadata is recorded in association with a reproduction start time at which a scene is reproduced.

A filename of a metadata file is determined so that the metadata file can be associated with each stream file and clip information file. Specifically, metadata associated with a stream file 01000.m2ts has a filename of 01000.meta. A time specified in metadata is converted into a packet number of a packet contained in a stream file by clip information, and the packet number is designated as a reproduction start position.

Now, a procedure of reproducing data from an optical disk which is performed by the reproducing apparatus shown in FIG. 1 will be described below.

To begin with, the optical disk 101 is loaded in the reproducing apparatus, and a user issues a reproduction start command. The reproduction start command is executed by, for example, pressing a reproduction start button on a remote control (not shown). The reproduction start command issued from the remote control is transferred to the system control unit 113 via the remote-control reception unit 115. In response to the command, the system control unit 113 invokes a program stored in a read-only memory (ROM) incorporated therein, and thus initiates reproduction according to the reproduction start command.

After initiating reproduction, the system control unit 113 reads file management data from the optical disk 101. The file management data may be general-purpose file management data stipulated in a universal disc format (UDF). As for concrete system actions to be performed in this case, the system control unit 113 issues a data read command to the drive control unit 106 so that data will be read from a predefined file management data storage area. In response to the command, the drive control unit 106 controls the servomechanism 105 so as to control the rotating speed of the optical disk 101 and the position of the optical pickup 102, and thus reads data from the designated area. Moreover, the drive control unit 106 controls the reproduced signal processing unit 103 so as to analyze a signal read from the optical disk, decode the signal, correct an error, and sort data items. Consequently, data for one sector is produced. The produced data is transferred to the system control unit 113 via the drive control unit 106. The system control unit 113 repeatedly executes data read, during which one sector is read, so as to read an entire area in which the file management data is recorded.

When reading of file management data is completed as mentioned above, an info.dvr file is read in order to acquire a kind of application, the number of play lists, and filenames of play list files. Herein, the application and play list files are recorded in the optical disk 101.

Thereafter, the menu.java file 202 containing a menu display program is read in order to display a menu. The menu.java file is written in Java®, and executed in a Java program execution environment (virtual machine) within the system control unit 113. Consequently, menu display programmed in advance is performed. A menu to be displayed presents information on the contents of a content recorded on the optical disk 101, information for use in selecting or designating a chapter at which reproduction is initiated, or information for use in retrieving a desired scene. In the reproducing apparatus of the present embodiment, a scene can be retrieved using metadata. The menu shall be programmed as one of menus to be provided by the menu display program 202. The menu display program need not always be written in Java but can be written in a general-purpose programming language such as Basic or C without any problem.

Next, a procedure of reproducing a stream file will be described below.

The system control unit 113 uses file management data to specify a designated stream file and a reproduction start position, and reads data from the optical disk 101. A signal read from the optical disk 101 is transmitted to the output control unit 104. The output control unit 104 samples data designated by the system control unit 113 from the data read from the optical disk 101, and supplies it to each of the audio signal decoding unit 107, video signal decoding unit 109, and graphic display unit 111.

The audio signal decoding unit 107 decodes received audio data, and transmits an audio signal via the audio signal output terminal 108.

The video signal decoding unit 109 decodes received video data and transmits a video signal to the video synthesis unit 110. Moreover, the graphic display unit 111 decodes received caption data and graphic data, and transmits a video signal to the video synthesis unit 110. The video synthesis unit 110 synthesizes the video signals sent from the video signal decoding unit 109 and graphic display unit 111 respectively, and transmits a synthetic signal via the video output terminal 112.

The system control unit 113 repeatedly executes the foregoing processing so as to reproduce video and sounds.

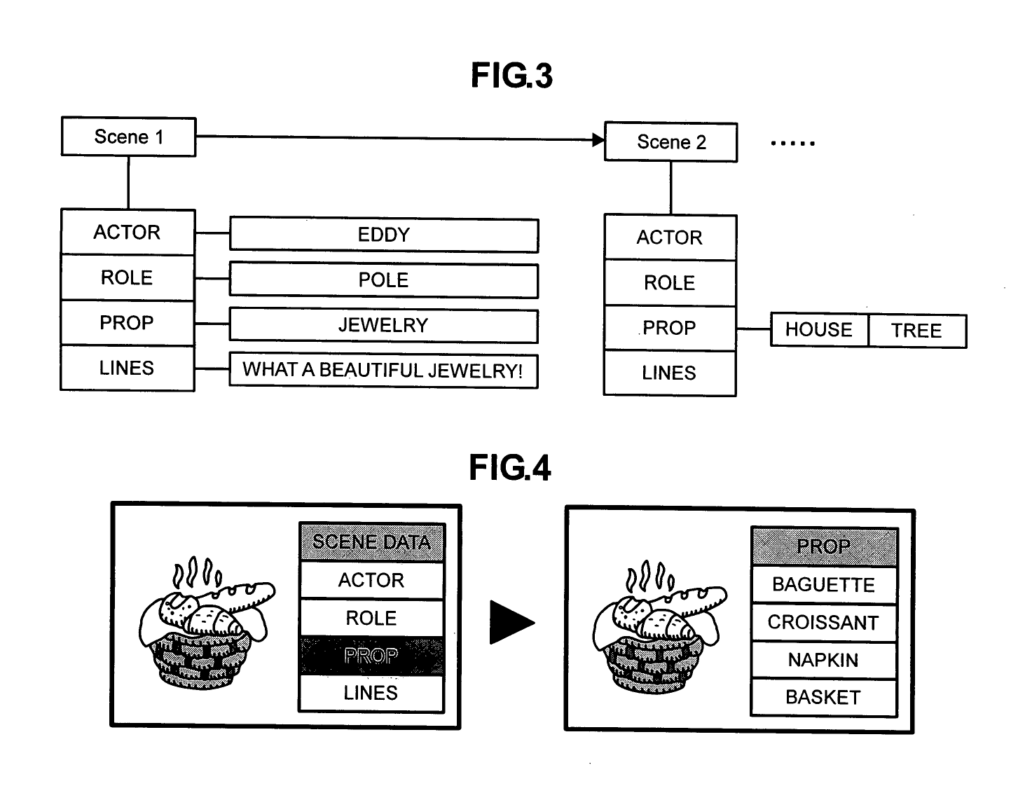

FIG. 3 shows an example of metadata to be recorded in a recording medium employed in the present embodiment.

According to a metadata structure shown in FIG. 3, a scene contained in a content recorded on an optical disk and relevant keywords form a hierarchical structure. FIG. 3 shows an example including only two scenes. In reality, all scenes contained in a recorded content have keywords subordinated thereto in the form of the hierarchical structure like the one shown in FIG. 3. The keywords relevant to each scene include, for example, names of actors appearing in the scene, roles the respective actors play in a drama, props and buildings employed in the scene, and lines employed in the scene.

The metadata structure is not limited to the one shown in FIG. 3 as long as each scene has keywords subordinated thereto. For example, each scene may have keywords other than those shown in FIG. 3 subordinated thereto. When the number of keywords is larger, a user will find it easier to retrieve a desired scene. However, it poses a problem in that a data rate of metadata increases. Preferably, pieces of important information needed to retrieve a scene should be strictly selected and recorded. In this case, keywords that should be subordinated to each content and keywords that may be or may not be subordinated thereto depending on a contents provider should be stipulated. Reproducing apparatuses should be designed to display mandatory keywords without fail, and display of arbitrary keywords is up to each apparatus. The stipulation ensures the interchangeability of an optical disk among reproducing apparatuses.

The order in which keywords are arranged is not limited to the one shown in FIG. 3. Moreover, a plurality of items may be associated with one keyword. For example, when two actors appear in one scene, two actors' names and two roles are recorded as keywords. Furthermore, no item may be associated with a keyword though it depends on a scene. For example, when a scene is composed of buildings alone, since neither actor nor lines are needed, no information should be recorded as a keyword. In this case, a code signifying the absence of a keyword, for example, a code 00 may be predefined and recoded in association with the scene. Otherwise, None or—may be recorded as character data. Moreover, keywords may have a relationship of dependency. For example, assuming that an actor A has a prop A, keywords of the actor and prop may have the relationship of dependency.

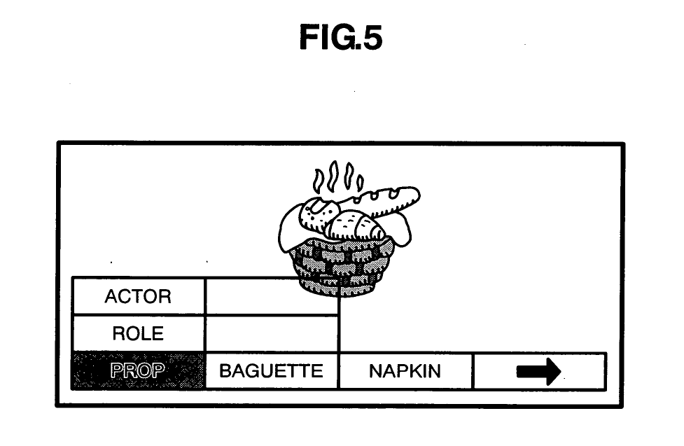

FIG. 4 shows a concrete example of scene data display achieved using metadata.

If a user selects a scene data display menu during reproduction of a scene, metadata items recorded in relation to the scene are displayed on the screen. In the example shown in FIG. 4, metadata items of Actor, Role, Prop, and Lines are displayed in the right-hand part of the screen on which the scene is being reproduced. The user selects one of the metadata items displayed which the user wants to know in detail. In the example shown in FIG. 4, Prop is selected, and the details, that is, keywords are displayed. For selection of metadata, the user uses a remote control or the like. At this time, if the reproducing apparatus has a feature of highlighting a selected item in a different color along with a vertical movement of a cursor or a feature of moving an arrow-shaped icon that is graphically displayed, user-friendliness would improve.

When a metadata item to be displayed in detail is selected, keywords associated with the metadata are displayed. Herein, keywords of Baguette, Croissant, Napkin, Basket are displayed in the right-hand part of the screen on which a scene is being reproduced. The displayed keywords help the user learn the details of the scene being reproduced.

An effective usage of the scene data display will be described as an example. For instance, after a user has enjoyed a movie, the user may want to reproduce a scene, which has impressed the user, so as to learn the details of the scene. In this case, metadata recorded in relation to the scene is displayed so that the user can learn the name of an actor appearing in the scene, read impressive lines, or learn a location. Consequently, the user will care for the movie and understand it in depth.

In the example shown in FIG. 4, during scene data display, metadata items such as Actor and Role, and keywords that are details of the metadata items are displayed in different screen images. However, the display method is not limited to the one shown in FIG. 4. For example, as shown in FIG. 5, metadata items recorded in relation to a scene may be displayed together with keywords. In this case, if the number of keywords is so large that the keywords cannot be contained in one screen image, a user may be able to scroll the display of keywords. Otherwise, the display of keywords may be changed from one to another at intervals of a certain time irrespective of whether a user performs a manipulation. Thus, all keywords may be displayed.

The reproducing apparatus may read metadata so as to display scene data in response to a user's scene data display command or responsively to loading of a disk in the apparatus. The reading timing is not limited to any specific one. Furthermore, as for metadata that has been displayed as scene data once, the results of reading the metadata should be temporarily held in, for example, the storage device 114. When the same scene data is displayed again, the held results of reading are used to shorten a time required for reading metadata. Consequently, the data can be displayed quickly.

As for the metadata structure shown in FIG. 3, each scene contains relevant metadata. Consequently, a user who wants to display data relevant to each scene so as to learn the details of the scene will find the metadata structure user-friendly. Moreover, a contents producer should merely record keywords relevant to each scene as metadata. Moreover, the metadata structure is so simple that creation of metadata needs little labor.

On the other hand, the metadata structure shown in FIG. 3 would prove neither useful nor user-friendly in a case where a user wants to retrieve a desired scene from among a large number of scenes. For example, assume that a user reproduces a content relative to which the same metadata structure as the one shown in FIG. 3 is recorded and wants to retrieve the user's favorite scene. At this time, many users recall the desired scene and try to retrieve the desired scene using various keywords including names of actors appearing in the scene, roles played by the actors, and props employed in the scene. However, according to the metadata structure shown in FIG. 3, since various keywords are subordinated to each scene, the keywords can be retrieved based on the scene but the scene cannot be retrieved based on the keywords. Namely, a user cannot retrieve the scene using the keywords but has to quickly reproduce the content so as to search the desired scene or search the desired scene from a screen image showing a list of thumbnails of scenes. If the recording time of a content is short and the number of scenes is small, the work is not very hard to do. However, when the recording time of a content is long and the content includes many scenes, the work of searching a desired scene from the content is very hard to do.

The reproducing apparatus in accordance with the present embodiment is designed to provide a user with an easy-to-use feature that transforms a metadata structure, which is recorded on a recording medium, from one to another and utilizes transformed metadata.

Actions to be performed in order to transform a metadata structure within the reproducing apparatus of the present embodiment will be described below.

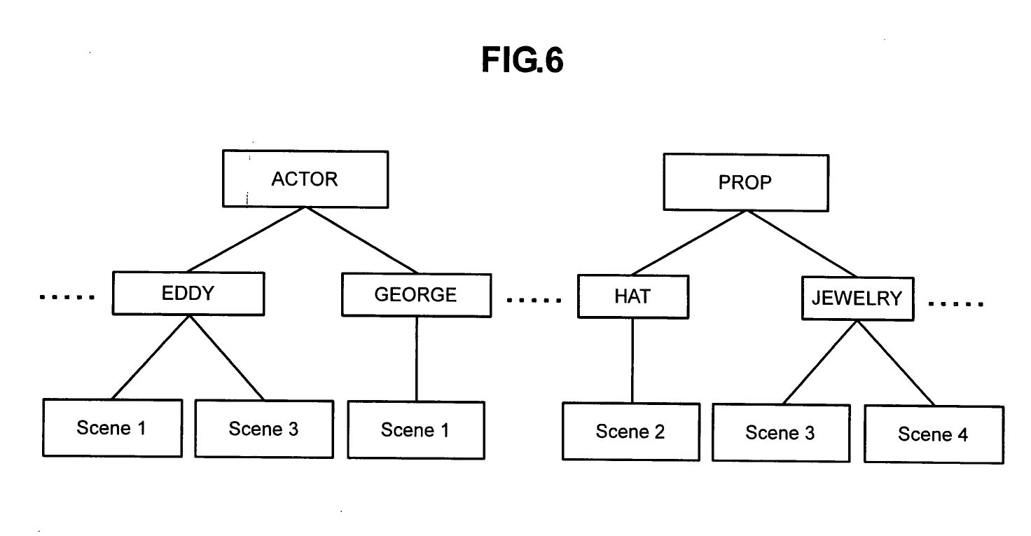

FIG. 6 shows an example of a transformed metadata structure.

The metadata structure shown in FIG. 6 has metadata items listed at the highest hierarchical level, keywords listed at the second highest hierarchical level, and scenes listed at the lowest hierarchical level. The keywords have the scenes subordinated thereto. The metadata structure shown in FIG. 6 will be described by taking a concrete example for instance. A metadata item of Actor has keywords of actors' names Eddy and George subordinated thereto. Scenes in which the actor Eddy appears such as Scene 1 and Scene 3 are associated with the keyword Eddy. Apparently, the scenes in which the actor Eddy appears are only two scenes of Scene 1 and Scene 3.

A conceivable usage of the metadata structure is retrieval of a scene based on a keyword. In the metadata structure shown in FIG. 3, retrieval of a scene is hard to do. In the metadata structure shown in FIG. 6, once a keyword is specified as a condition for retrieval, a scene associated with the keyword can be readily retrieved.

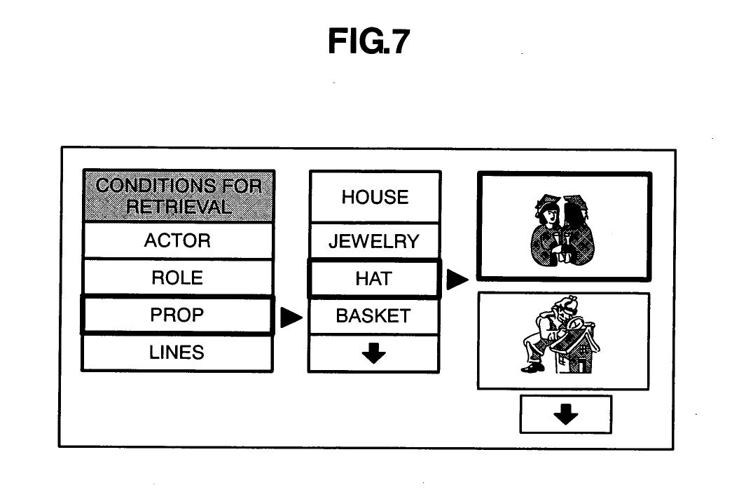

FIG. 7 shows a concrete example of display of a scene retrieval image using metadata.

When a user selects scene retrieval from a menu, metadata items are displayed as candidates for a condition for retrieval on the screen. Herein, metadata items Actor, Role, Prop, and Lines are displayed. Desired metadata is selected from among the displayed metadata items. Herein, Prop is selected, and retrieval is performed using Prop as the highest hierarchical concept.

When a metadata item regarded as the highest hierarchical concept for retrieval is selected, a list of keywords associated with the metadata item is displayed. Herein, values of House, Jewelry, Hat, and Basket are displayed. The user selects a desired keyword from among the displayed keywords. Herein, Hat is selected. The selected keyword is regarded as a condition for retrieval. The results of retrieval of scenes that meet the condition are displayed in the form of a list. In other words, scenes associated with the keyword Hat are displayed. The results of the retrieval may be displayed in the form of thumbnails. Otherwise, character data signifying a scene, for example, “Chapter 1, Scene 4, 0:48” may be displayed.

When the user selects a desired scene from among the scenes retrieved according to the foregoing procedure, the system control unit 113 reproduces a video stream identified with a time specified in the selected metadata. Specifically, a reproduction start time specified in metadata relevant to the selected scene is converted into a packet number, which is assigned to a packet contained in a stream, using the clip information file 204. The stream file 205 is then reproduced from a predetermined packet number position therein.

Thus, the user can select the desired scene from the displayed list of the results of scene retrieval, and reproduce the selected scene.

A plurality of metadata structures may be recorded on an optical disk. For example, not only the structure shown in FIG. 3 but also the structure shown in FIG. 6 may be recorded. In this case, the employment of the metadata structure shown in FIG. 6 and recorded on the optical disk is more efficient than the transformation of the structure shown in FIG. 3 into the structure shown in FIG. 6.

When a plurality of metadata structures is recorded as a whole, information helping the reproducing apparatus identify a metadata structure recorded on a disk should preferably be employed. For example, a metadata structure identification file like the one 207 shown in FIG. 2 should be employed. The metadata structure identification file contains, for example, two bits. Specifically, when only the metadata structure shown in FIG. 3 is recorded, bits of 01 are contained. When only the metadata structure shown in FIG. 6 is recorded, bits of 10 are contained. When both the structures are recorded, bits of 11 are contained. When neither of the structures is recorded, bits of 00 are contained. The reproducing apparatus that reproduces data from the disk reads the bits to identify a metadata structure recorded on the disk, and executes predetermined metadata structure transformation.

In addition to the metadata structures shown in FIG. 3 and FIG. 6, any other metadata structure may be recorded on a disk. In this case, since three metadata structures are recorded, the structures cannot be discriminated from one another using the above two bits. Therefore, the number of bits is increased appropriately.

Preferably, the metadata structure identification file should be recorded together with metadata. Even if the file is not recorded, the reproducing apparatus should be able to execute metadata structure transformation. For example, if the metadata structure shown in FIG. 3 is recorded on a disk but the metadata structure identification file is not recorded thereon, the reproducing apparatus analyzes recorded metadata so as to transform the recorded metadata structure into a predetermined metadata structure.

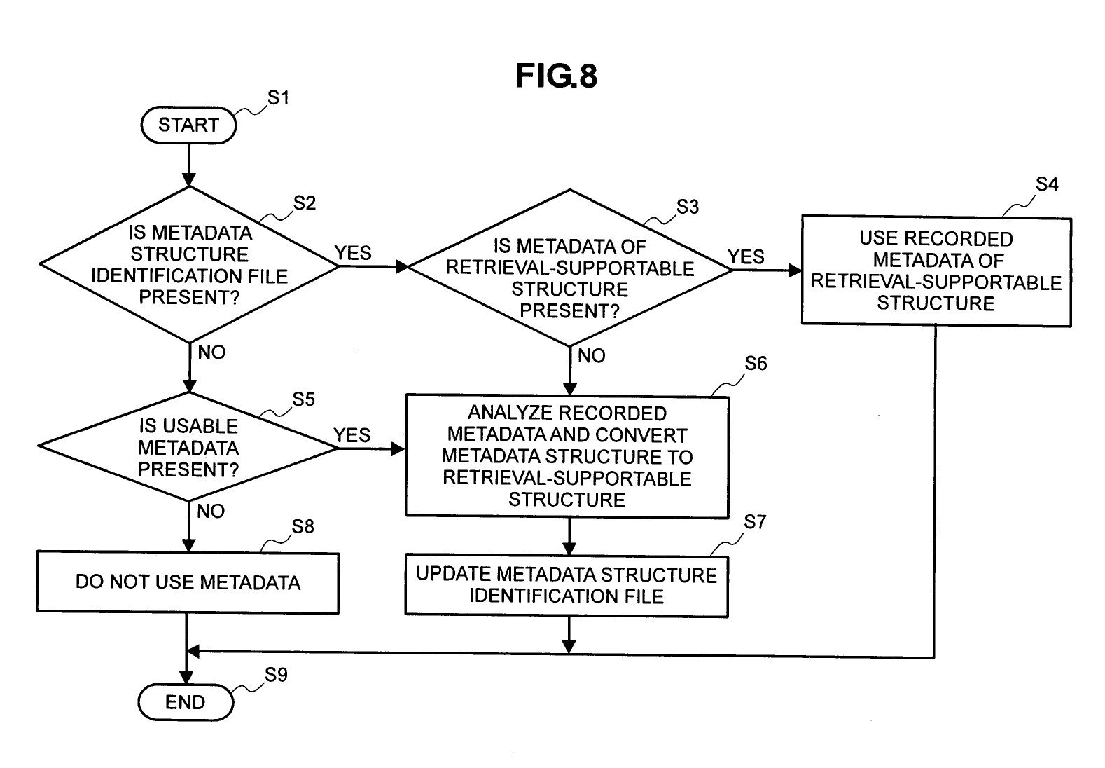

FIG. 8 is a flowchart describing a procedure of transforming a metadata structure.

To begin with, transformation is invoked at step S1. As step S2, a metadata structure identification file is checked to see if it is present.

If the metadata structure identification file is present, the contents of the file are checked at step S3 to see if metadata of a retrieval supportable structure is recorded. What is referred to as metadata of the retrieval supportable structure is a metadata structure that can be utilized in case the reproducing apparatus provides the feature of retrieving a desired scene using keywords.

If metadata of the retrieval supportable structure is recorded, the reproducing apparatus does not execute metadata structure transformation but uses the metadata of the retrieval supportable structure recorded on the disk.

If the metadata of the retrieval supportable structure is not recorded, the metadata structure like the one shown in FIG. 3 which is recorded on the disk is transformed into a retrieval supportable metadata structure like the one shown in FIG. 6. The transformation to be executed at step S6 will be described later.

After the metadata structure is transformed into the retrieval supportable metadata structure, the metadata structure identification file is updated at step S7. Assuming that the structure shown in FIG. 3 is transformed into the one shown in FIG. 6 and the transformed metadata is are rerecorded on the disk, the bits 01 signifying that only the structure shown in FIG. 3 is recorded are rewritten with the bits 11 signifying that both the structures shown in FIG. 3 and FIG. 6 are recorded.

On the other hand, if the metadata structure identification file is absent, the disk is checked at step S5 to see if it contains useful metadata. The useful metadata is, for example, metadata containing keywords associated with a scene.

If the useful metadata is present, for example, if the metadata structure identification file is not recorded but metadata is recorded in the metadata structure shown in FIG. 3, the metadata structure is transformed into the predetermined structure at step S6.

If the useful metadata is absent, that is, if any metadata is not recorded or metadata usable to retrieve a scene is not recorded, a decision is made not to use metadata. The reproducing apparatus displays the fact that metadata-based scene retrieval cannot be performed

Owing to the foregoing procedure, a scene retrieving feature is provided so that metadata recorded in advance on the disk can be utilized.

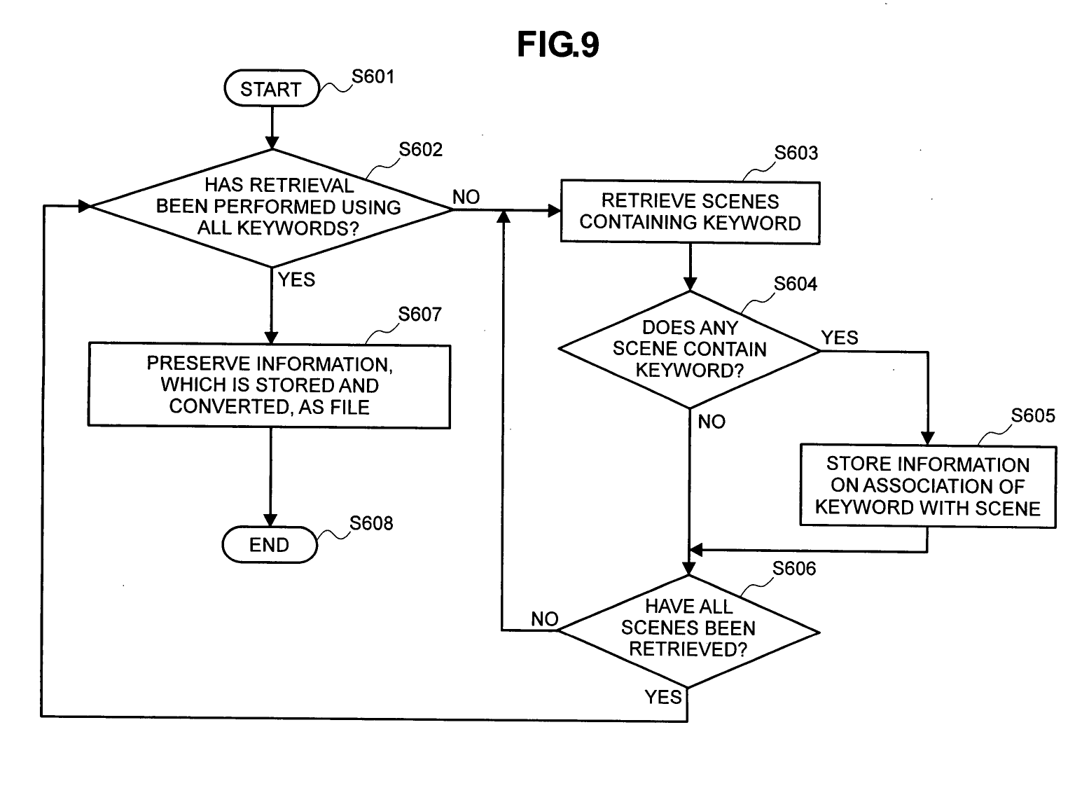

FIG. 9 is a flowchart describing a metadata structure transformation procedure. Step S6 mentioned in FIG. 8 is described in detail. According to the procedure, a keyword contained in metadata is regarded as a condition for retrieval. Scenes containing the keyword are retrieved, and the metadata structure is transformed into the metadata structure that has scenes subordinated to each keyword. First, at step S602, retrieval based on each keyword is checked. If scene retrieval to be performed using every keyword as a condition for retrieval is not completed, for example, if retrieval based on only one of five keywords is completed, any of the keywords that have not been used for retrieval is designated as the next condition for retrieval. Control is then passed to step S603.

On the other hand, if scene retrieval to be performed using every keyword as a condition for retrieval is completed, control is passed to step S607.

At step S603, scenes containing as metadata the keyword designated as a condition for retrieval at step S602 are retrieved. At this time, if all scenes are searched, search may be started with any scene. Normally, the scenes are sequentially searched from a leading scene to a trailing scene.

At step S604, a result of retrieval is checked after one scene is searched.

If the result of retrieval reveals that the scene contains the keyword serving as the condition for retrieval, information on association of the keyword with the scene is stored at step S605. Specifically, when an actor's name Eddy is used as a keyword, if the keyword is contained in Scene 1, information signifying “Condition for retrieval: Eddy, Scene concerned: Scene 1” is stored. A destination of storage where the information is stored is, for example, the storage device 114 included in the reproducing apparatus. After the information is stored, control is passed to step S606.

On the other hand, if the result of retrieval reveals that the keyword that is the condition for retrieval is not contained in the scene, control is passed to step S606.

At step S606, a decision is made of whether all scenes have been retrieved using the keyword designated as the condition for retrieval.

If a scene that has not been retrieved is found, for example, if only one of five scenes has been retrieved, control is returned to step S603. Retrieval of the remaining four scenes is executed.

On the other hand, if a scene that has not been retrieved is unfound, or in other words, if retrieval of all scenes is completed, control is returned to step S602. A keyword to be regarded as the next condition for retrieval is designated.

At step S607, the information on association of a keyword with a scene that is stored at step S604 is preserved as a file. The file to be preserved is the metadata file 206. Preferably, a transformed metadata file should be able to be discriminated from an untransformed metadata file. For example, if an untransformed file is overwritten with a transformed file, the untransformed metadata is deleted. This deteriorates user-friendliness. Consequently, for example, a filename different from a filename assigned to untransformed metadata, such as, 0100.trns is assigned to the transformed metadata. A destination of storage where the file is stored may be below a META directory in the same manner as the destination of storage where a metadata file is stored. Otherwise, the file may be stored below a unique directory, for example, a TRNS directory.

File preservation of step S607 is not limited to the execution timing described in FIG. 9. In the example shown in FIG. 9, after all scenes are retrieved by designating all keywords as conditions for retrieval, file preservation is performed once. Aside from the timing, the file preservation may be performed after all scenes are retrieved by designating one keyword as a condition for retrieval. At this time, a filename need not be changed relative to each keyword, but the same file may be overwritten with new data. In this case, the file preservation is performed by the same number of times as the number of keywords. This would bring about the demerit that the time required for file preservation gets longer. On the other hand, since a result of retrieval is preserved in a file every after completion of retrieval based on one keyword, a storage area in which the result of retrieval is temporarily stored should be able to hold mere one keyword. This method would be effective for a reproducing apparatus in which a large storage area cannot be reserved.

Moreover, a metadata file in which a result of transformation of a metadata structure is contained has been described to be recorded on an optical disk. However, the destination of storage where the metadata file is stored is not limited to the optical disk. For example, the metadata file may be stored in the storage device 114 included in the reproducing apparatus. The adoption of the storage device 114 as the destination would prove effective in a case where the optical disk is dedicated to data read or the optical disk does not have room for transformed metadata. At this time, a content to be reproduced exists on the optical disk and metadata exists in the storage device 114 included in the reproducing apparatus. Therefore, the relationship of correspondence of the optical disk with the metadata should be stored concurrently. Information inherent to the optical disk, for example, a disk ID may be stored together with metadata. Once metadata structure transformation is executed, after audiovisual data is reproduced from the optical disk, if part of the audiovisual data is retrieved, transformed metadata is read from the storage device 114 included in the reproducing apparatus in order to provide a retrieving feature. Owing to the foregoing components, transformation of a metadata structure on one optical disk should be performed only once. This obviates the necessity of a time-consuming procedure of transforming a metadata structure every time an optical disk is inserted into the reproducing apparatus. Moreover, the storage device included in the reproducing apparatus is not limited to a hard disk but may be a semiconductor memory or a memory card.

For the same reason as the reason why a metadata file may be stored in an external storage device, the metadata structure identification file may be stored in a storage device other than an optical disk, for example, in the storage device 114 included in the reproducing apparatus.

Moreover, in the aforesaid embodiment, a metadata structure is transformed at the timing when a user selects scene retrieval from a menu. The timing of transforming a metadata file is not limited to this one. For example, the timing may be when the optical disk is inserted into the reproducing apparatus or when a menu screen image is displayed. In the aforesaid example, the reproducing apparatus autonomously transforms a metadata structure, and a user is unaware of the transformation of a metadata structure. If Metadata Structure Transformation or the like may be added to menu items, when a user selects the menu item, metadata structure transformation may be executed. Control may be extended as the user intends.

Moreover, if a plurality of metadata structures is recorded on an optical disk, the reproducing apparatus should preferably adopt the commonest metadata structure. What is referred to as the commonest metadata structure is a metadata structure intended to be adopted by many reproducing apparatuses. The reproducing apparatus therefore should display a screen image, which utilizes metadata, as a top priority. However, for example, if a contents provider records metadata use priorities on an optical disk, screen images may be displayed according to the priorities. Moreover, assuming that the reproducing apparatus stores a history of reproduction of audiovisual data from a certain optical disk, when the audiovisual data is reproduced next, the history is read so that metadata identical to that used previously may be used to display a screen image.

As mentioned above, when a metadata structure recorded in advance on a disk is transformed, a retrieving feature which a user would find helpful can be provided.

Needless to say, an optical disk may not be employed but a content available over a network, that is, video data and metadata may be downloaded for use. Specifically, the video data and metadata downloaded over the network is fetched into the storage device included in the reproducing apparatus, and then read. Thus, the same feature as the one provided when data is read from an optical disk can be provided.

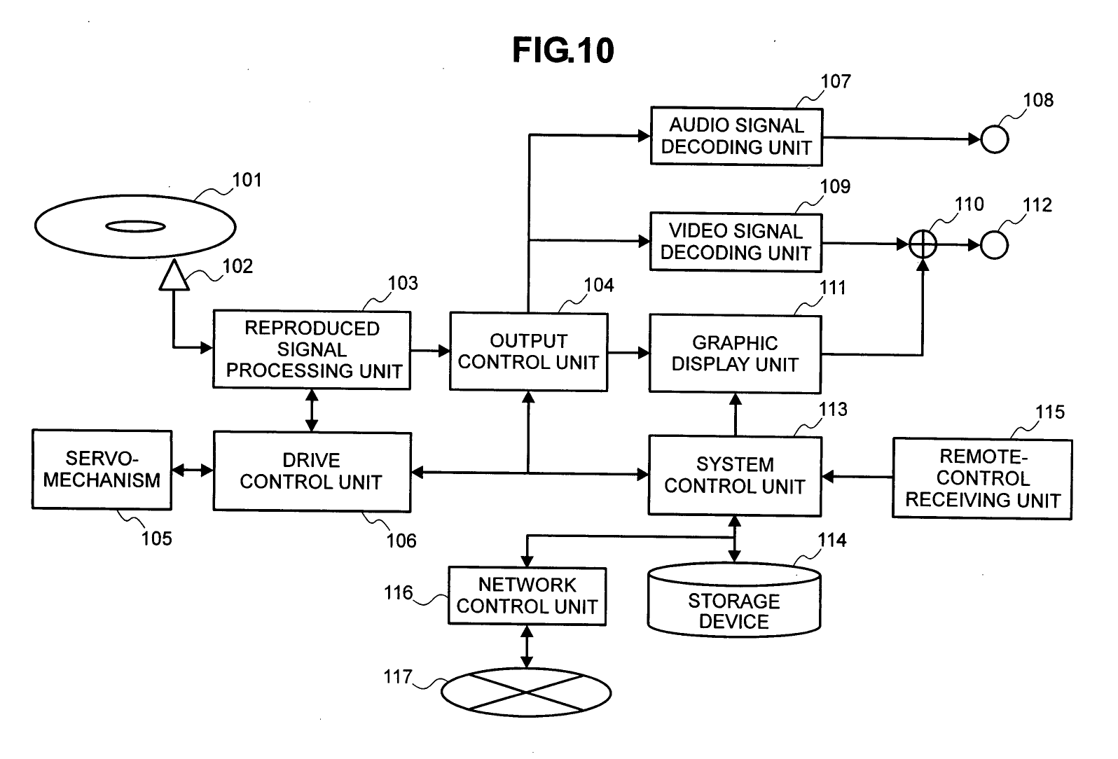

FIG. 10 is a block diagram of a reproducing apparatus connectable on a network.

In FIG. 10, there are shown the same components 101 to 115 as those shown in FIG. 1. Also shown are a network control unit 116 and a network 117.

In the reproducing apparatus shown in FIG. 10, a user selects Content Download through a menu display screen image or the like, and initiates download of a desired content and relevant metadata. Specifically, the system control unit 113 controls the network control unit 116 so that the predetermined content will be downloaded from a file server (not shown) accommodated in the external network 117. Incidentally, a user can designate a file server to be employed and a uniform resource locator (URL) indicating the location of a file. The URL is a predetermined one, and the user can obtain the URL through any of various pieces of means. For example, when a user pays a contents provider for a predetermined content, the user is granted the authority to download the predetermined content and provided with the URL. Otherwise, the URL is obtained from information recorded as an info.dvr file on a purchased optical disk.

A content downloaded as mentioned above is stored in the storage device 114 included in the reproducing apparatus. The content is read from the storage device 114 for use, whereby the same features as a feature of reproducing a content from an optical disk, a feature of transforming a metadata structure, and a feature of retrieving a scene which have been described previously are provided.

A case where both video data and metadata are downloaded has been described. Data items to be downloaded are not limited to the video data and metadata. For example, video data alone may be downloaded over a network, and metadata may be read from an optical disk. Furthermore, a metadata file may be downloaded over the network. For example, when metadata relevant to a content stored on an optical disk has the metadata structure shown in FIG. 3, a metadata file containing the metadata relevant to the content in the metadata structure shown in FIG. 6 may be downloaded over a network. Needless to say, a metadata file containing a metadata structure other than the metadata structure shown in FIG. 6 may be downloaded.

As mentioned above, when various data items are downloaded over a network, the reproducing apparatus becomes user-friendly.

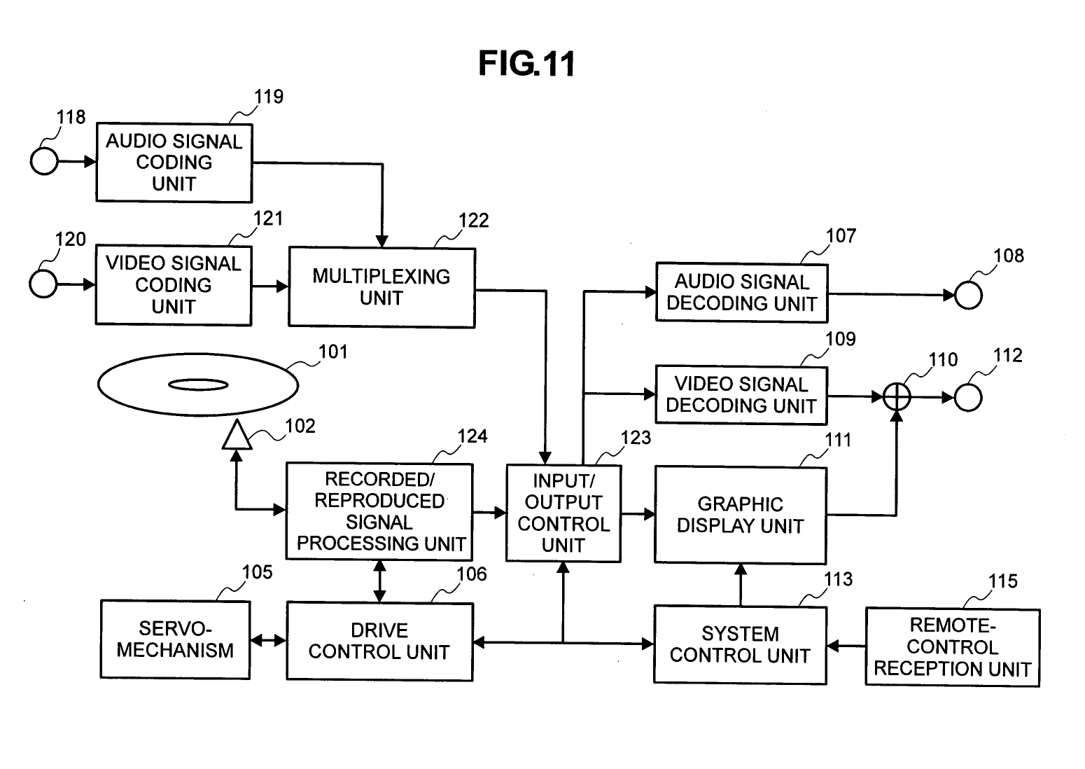

FIG. 11 is a block diagram of a recording apparatus in accordance with the present embodiment.

In FIG. 11, there are shown the same components 101 to 115 as those shown in FIG. 1. Also shown are an audio signal input terminal 118, an audio signal coding unit 119, a video signal input terminal 120, a video signal coding unit 121, a multiplexing unit 122, an input/output control unit 123, and a recorded/reproduced signal processing unit.

Actions to be performed for recording in the recording apparatus shown in FIG. 11 will be described below.

When a user manipulates a remote control (not shown) to initiate recording, the remote-control reception unit 115 receives a recording start command sent from the remote control, and transfers the command to the system control unit 113.

In response to the recording start command, the system control unit 113 invokes a recording program residing in the system control unit so as to initiate recording.

First, file management data is read from the optical disk 101, and filenames of stored files and storage sectors thereof are identified. Based on these pieces of information, filenames to be assigned to a stream file and a clip information file that are newly created are determined. The file management data is used to identify a free space on the optical disk. Control is extended so that the stream file will be stored in the free space.

The system control unit 113 uses predetermined parameters to instruct the audio signal coding unit 119 and video signal coding unit 121 to encode sounds and video respectively. The audio signal coding unit 119 encodes an audio signal according to, for example, a linear PCM method. The video signal coding unit 121 encodes a video signal according to, for example, the MPEG2 method. The encoded audio and video signals are transferred as MPEG packets to the multiplexing unit 122. The multiplexing unit 122 multiplexes the audio packet and video packet to produce an MPEG transport stream, and transfers the stream to the input/output control unit 123.

The input/output control unit 123 is set to a recording mode by the system control unit 113, and appends a packet header to each of received packets. A record packet is converted into a form recordable in a sector on an optical disk, and then supplied as sector data to the recorded/reproduced signal processing unit 124.

The system control unit 113 issues a sector data recording command to the drive control unit 106. Specifically, the system control unit 113 instructs the drive control unit 106 to store the sector data in a free sector on the optical disk which is identified based on the file management data.

In response to the sector data recording command sent from the system control unit 113, the drive control unit 106 controls the servomechanism 105 so that the optical disk will be rotated at a predetermined rotating speed. Moreover, the optical pickup 102 is moved to the position of a recordable sector. Moreover, the drive control unit 106 instructs the recorded/reproduced signal processing unit 124 to record the sector data received from the input/output control unit 123. The recorded/reproduced signal processing unit 124 performs predetermined sorting, error correcting code appending, and modulation on the received sector data. When the optical pickup 102 reaches the instructed sector recording position, the sector data is written on the optical disk 101.

The foregoing processing is repeated in order to store the stream of desired video and audio signals on the optical disk.

When a user enters a recording end command, the system control unit 113 terminates the stream recording, creates the clip information file 204, and records the file on the optical disk. Moreover, information on the recording of the stream file 205 and clip information file 204 is appended to the file management data. Furthermore, if necessary, the play list file 203 is updated and appended to the file management data. Thus, the previous file management data is replaced with new one.

Owing to the foregoing processing, the received video and audio signals are recorded as a stream file on the optical disk.

Moreover, similarly to the network connectable reproducing apparatus shown in FIG. 10, a network connectable recording apparatus can be realized. If the recording apparatus in accordance with the present embodiment can be connected on a network, video data and metadata acquired over the network can be recorded on an optical disk. Thus, a more user-friendly recording apparatus is realized. Data distribution over networks is expected to flourish and the demand for the network connectable recording apparatus is expected to grow.

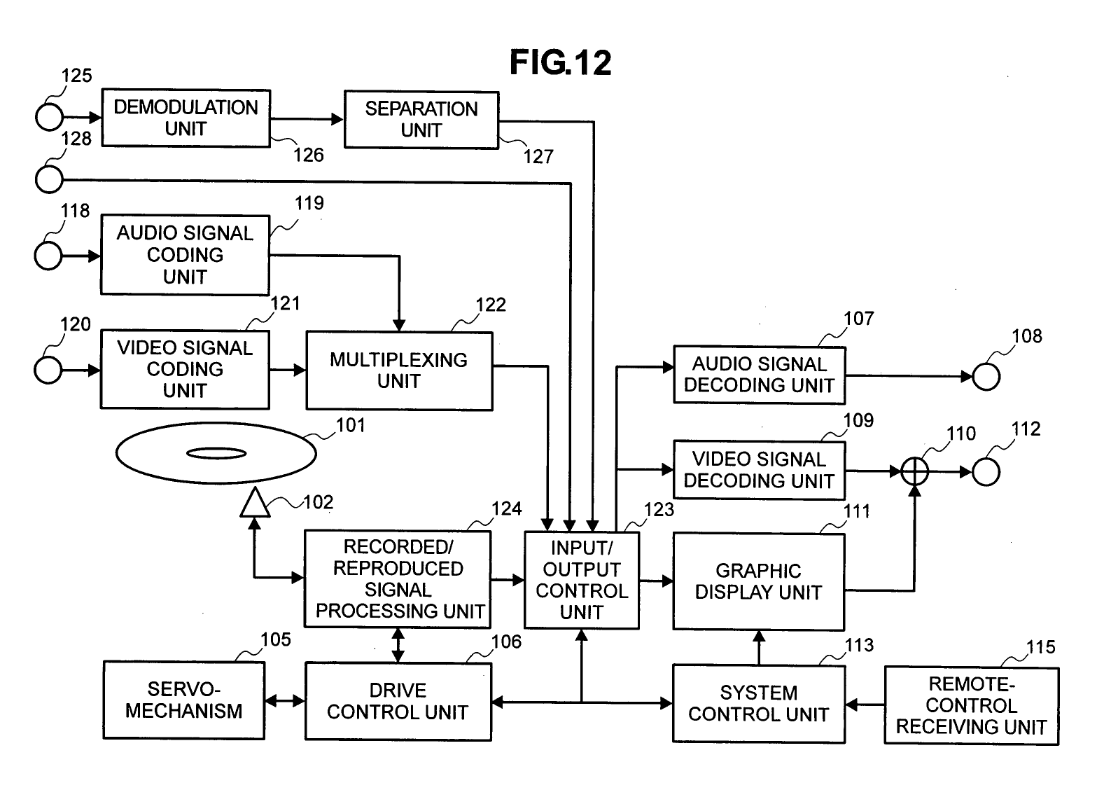

FIG. 12 shows a recording and reproducing apparatus capable of receiving a digital broadcasting service, recording data on a recording medium, and reproducing recorded data to produce a reproduced output.

In the recording and reproducing apparatus shown in FIG. 12, even when digital data whose quantity to be encoded is compressed is received externally through broadcasting or communication, the digital data can be recorded on a recording medium as it is, and read and reproduced.

In FIG. 12, there are shown the same components 101 to 124 as those shown in FIG. 11. Also shown are an antenna input terminal 125 via which waves intercepted by an antenna are received, a demodulation unit 126, a separation unit 127 that separates the demodulated digital signal into audio data, video data, and other data, and a digital input terminal 128 via which audiovisual data compressed by other equipment is received.

Actions to be performed in order to receive a digital broadcasting service and record received digital data will be described below.

First, a signal transmitted and received through digital broadcasting is applied to the antenna input terminal 125, demodulated and separated according to a predetermined method by the demodulation unit 302 and separation unit 303 respectively, and then transferred to the input/output control unit 123. The resultant input signal is written on the optical disk 101 by means of the drive control unit 106, servomechanism 105, optical pickup 102, and recorded/reproduced signal processing unit 124. Moreover, a digital signal applied to the digital input terminal 128 is transferred directly to the input/output control unit 123, and written on the optical disk 101 according to the same procedure as the one for recording other data.

For reproduction, digital data read from the optical disk 101 in response to a user's command is transferred to the audio signal decoding unit 107 and video signal decoding unit 109 via the input/output control unit 123. After performing predetermined audio signal decoding, the audio signal decoding unit 107 converts digital data into an analog signal. The analog signal is transferred to an external amplifier via the audio output terminal 108, whereby sounds are reproduced and radiated from a loudspeaker or the like. After performing predetermined video signal decoding, the video signal decoding unit 109 converts digital data into an analog signal. The video synthesis unit 110 synthesizes caption data and graphic data and transmits the resultant data via the video signal output terminal 112. A video signal transmitted via the video signal output terminal is transferred to an external monitor, whereby video is displayed.

According to the foregoing procedure, the apparatus in accordance with the present embodiment can record or reproduce digital data distributed through digital broadcasting.

In the recording apparatus of the present embodiment, metadata is recorded concurrently with recording of a stream file. For example, video data expressing each scene is automatically recognized, and names of actors appearing in the scene, props employed in the scene, and other information are automatically appended to the video data as metadata. Moreover, a metadata recording method is not limited to the above one. For example, a steam and metadata may be recorded mutually independently. In this case, a user selects a scene to which the user wants to append metadata, and designates metadata items and keywords which are associated with the scene. The metadata designated by the user is contained in a metadata file together with video times. At this time, if information on a recorded metadata structure is contained in a metadata structure identification file, metadata structure transformation will be able to be performed more efficiently. This would prove user-friendly. However, the metadata structure identification file may not be recorded. This is because the recording apparatus of the present embodiment can analyze recorded metadata, retrieve a scene using a keyword as a condition for retrieval, and transform the metadata structure.

When metadata is recorded, not only metadata of a predetermined structure is recorded but also a plurality of metadata structures may be recorded. For example, the metadata of the predetermined structure may be transformed in order to record metadata helpful in scene retrieval.

As mentioned above, metadata of a predetermined structure is recorded concurrently with recording of a stream. Consequently, recording and reproducing apparatuses that are compatible with the metadata of the predetermined structure can share the same data. Moreover, when metadata other than that of the predetermined structure, for example, metadata helpful in scene retrieval is recorded, the recording and reproducing apparatuses compatible with the metadata can share the same data. Moreover, when information for use in identifying a recorded metadata structure is also recorded, user-friendliness further improves.

In the reproducing apparatus and recording apparatus of the present embodiment, not only metadata of a predetermined structure is transformed into that of other structure but also the metadata of the structure other than the predetermined structure is transformed into that of the predetermined structure. Consequently, for example, even when an optical disk does not support metadata of the predetermined structure and is poor in interchangeability, the apparatus of the present embodiment transforms metadata into that of the predetermined structure and records the metadata on an optical disk. Consequently, the optical disk becomes interchangeable among pieces of equipment.

A recording and reproducing apparatus that records or reproduces video data composed of a plurality of scenes includes: a reproduction unit that reproduces information relevant to a predetermined scene contained in the video data composed of a plurality of scenes; an output unit that transmits the relevant information reproduced by the reproduction unit to a display means; and a control unit that associates the scene with the relevant information. The predetermined scene associated with the relevant information by the control unit is retrieved. The recording and reproducing apparatus will prove user-friendly.

Furthermore, assuming that the recording and reproducing apparatus is designed to retrieve a predetermined scene associated with relevant information by the control unit and to display a thumbnail of a scene (which means a small image or a small image representative of a scene) on the display means, a user can readily grasp the contents of the scene. This is the merit of video data that is unavailable in notifying a user of character data.

Furthermore, assume that the recording and reproducing apparatus is designed so that: when a user selects relevant information, the control unit retrieves scenes associated with the relevant information, and displays thumbnails of the scenes on the display means; and when the user selects a desired thumbnail, the reproduction unit reproduces the scene concerned. In this case, even if the number of scenes is large, efficiency in retrieval can be ensured.

Since audiovisual (AV) data is associated with AV data management data and metadata, a range from the beginning of the AV data to a point at which some hours, minutes, and seconds have elapsed can be designated as a scene retrieved based on metadata. Consequently, a scene can be accurately and readily read. Even after scenes are associated with metadata (or after a metadata structure is transformed), the relationship remains unchanged. This leads to improved retrieving efficiency. Or in other words, while the relationship is held intact, scenes can be associated with metadata (or a metadata structure can be transformed).

In the reproducing apparatus, recording apparatus, and recording medium of the present embodiment, video data recorded on the recording medium and relevant metadata can be utilized in a predetermined structure. Moreover, a means for transforming a metadata structure into another is included. Consequently, when metadata of the predetermined structure is utilized, the same features as those of any other recording and reproducing apparatus can be provided. When metadata of the predetermined structure is transformed into metadata of another structure, the reproducing apparatus and recording apparatus of the present embodiment can provide a unique retrieving feature and user interface. When a metadata structure is transformed, if scene retrieval or screen image display cannot be efficiently achieved using metadata of a certain structure or cannot be performed according to user's likes, the user can select the easiest-to-use one from among a plurality of retrieving features or user interfaces. This leads to improved user-friendliness.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A recording and reproducing apparatus for recording or reproducing video data composed of a plurality of scenes, comprising:
a reproduction unit that reproduces information relevant to a predetermined scene contained in the video data composed of a plurality of scenes;
an output unit that transmits the relevant information reproduced by the reproduction unit to a display means; and
a control unit that associates a scene with the relevant information, wherein:
the scene associated with the relevant information by the control unit is retrieved.

2. The recording and reproducing apparatus according to claim 1, wherein:
the control unit retrieves the scene associated with the relevant information by the control unit; and
the output unit transmits a thumbnail of the scene to the display means.

3. The recording and reproducing apparatus according to claim 2, further including a selection unit at which a user selects relevant information, wherein:
when a user selects relevant information at the selection unit, the control unit retrieves scenes associated with the relevant information selected by the user, and the output means transmits thumbnails of the scenes to the display means; and
when the user selects a desired thumbnail, the reproduction unit reproduces the scene concerned.

4. A reproducing apparatus that reproduces audiovisual (AV) data recorded on a recording medium, management data of the AV data, and information relevant to the AV data, comprising:
a reproducing unit that reproduces the AV data, management data of the AV data, and information relevant to the AV data which are read from the recording medium;
an output unit that transmits the AV data read by the reproducing unit;
a user interface through which a user performs manipulations;
a control unit that controls the reproducing unit according to an entry made through the user interface; and
an information structure transformation unit that transforms the information relevant to the AV data from a first information structure to a second information structure, wherein:
under the control of the control unit, the information structure transformation unit transforms the first information structure recorded on the recording medium into the second information structure.

5. The reproducing apparatus according to claim 4, further comprising an information storage unit in which information is stored, wherein:
the control unit stores the second information structure, which is produced by the information structure transformation unit, in the information storage unit.

6. The reproducing apparatus according to claim 5, wherein the control unit stores in the information storage unit information, which is used to discriminate the first information structure recorded in advance on the recording medium from the second information structure produced by the information structure transformation unit, in association with identification data inherent to the recording medium.

7. The reproducing apparatus according to claim 6, wherein the control unit identifies an information structure on the basis of the information to be used to identify a recorded information structure.

8. The reproducing apparatus according to claim 7, further comprising a network connection unit that connects the reproducing apparatus on a network, wherein:
the control unit acquires information, which is stored in a file server to which the reproducing apparatus is connected over the network, over the network, and stores the acquired information in the information storage unit.

9. A recording apparatus that records audiovisual (AV) data, management data of the AV data, and information relevant to the AV data on a recording medium, comprising:
a reception circuit that receives AV data externally;
a recording-circuit that records the AV data received by the reception circuit on the recording medium;
a user interface through which a user performs manipulations;
a control unit that controls the circuits according to an entry made through the user interface;
an information structure transformation unit that transforms the information relevant to the AV data from a first information structure to a second information structure, wherein:
the control unit records the second information structure, which is produced by the information structure transformation unit, on the recording medium.

10. The recording apparatus according to claim 9, wherein the control unit records on the recording medium information, which is used to discriminate the first information structure recorded in advance on the recording medium from the second information structure produced by the information structure transformation unit, in association with identification data inherent to the recording medium.

11. The recording and reproducing apparatus according to claim 1, wherein:
the reproduction unit reproduces information relevant to each scene contained in the video data composed of a plurality of scenes; and
the control unit associates scenes with relevant information which is one of pieces of information relevant to the scenes and which is shared by different scenes.

12. The recording and reproducing apparatus according to claim 1, wherein the video data is video data composed of a plurality of scenes representing scenes that constitute video.

13. The recording and reproducing apparatus according to claim 12, wherein the video data is video data compressed according to the MPEG2 method, and the scene corresponds to a group of pictures.
